(19) United States
(12) Patent Application Publication
(10) Pub. No.: US 2010/0063716 A1
(43) Pub. Date: Mar. 11, 2010

(54) METHOD AND DEVICE FOR THE CONTROL OF AIR TRAFFIC MANAGEMENT AT AN AIRPORT

(76) Inventor: Raimund Brozat, Bensheim (DE)

Correspondence Address: HAYES SOLOWAY P.C., 3450 E. SUNRISE DRIVE, SUITE 140, TUCSON, AZ, 85718, US

(21) Appl. No.: 12/515,525

(22) PCT Filed: Nov. 23, 2007
(86) PCT No.: PCT/EP07/10217

§ 371 Date: May 19, 2009

(30) Foreign Application Priority Data
Nov. 24, 2006 (DE) 10 2006 055 568.6
Apr. 2, 2007 (DE) 10 2007 015 945.7

(51) Int. Cl. G08G 5/00; G08G 5/06

(52) U.S. Cl. 701/120

(57) ABSTRACT

In a method of controlling the air traffic management at an airport, optimized partial process sequences for the visit of an individual aircraft at the airport (flight visit) are determined by using an electronic data processing system including actual and/or forecast factors.

The present invention relates to a method and a device for the control of air traffic management at an airport.

The overall management of air traffic is subdivided into several partial processes which are carried out by different authorities largely independently from each other. The consequence of the lack of coordination is suboptimal flows of traffic at the airport.

There is therefore a need for an improved air traffic management at an airport in order to avoid or reduce delays and to better utilize available capacities, so that the costs for air service and airport operation can be reduced.

The present invention for the first time proposes a method and a device which are suitable to reach these goals. For this purpose, the invention provides a method for the control of air traffic management at an airport and a device for carrying out the method, in which an electronic data processing system is used to determine optimized partial process sequences for the visit of an individual aircraft at the airport (hereinafter referred to as flight visit) including actual (current) and/or forecast factors. It is of great importance for airport operation and in particular for aircraft handling and servicing to know, for example, when an approaching aircraft will arrive at the airport, and in particular on its parking position, to systematically and economically manage and dispose of resources (staff and handling and servicing equipment).

In the air traffic management at an airport, available capacity slots frequently remain unutilized because rigid rules and strategies of use lead to unused capacities on individual take-off and landing runways while other runways are often overloaded at the same time. When there is a high volume of traffic, the suboptimal utilization of the available runway capacity for take-offs and landings results in an unnecessary and disproportionately great increase in delays and lags. According to a first aspect of the invention, an optimum take-off and/or landing runway is therefore determined for a flight visit having regard to at least one of the following actual or forecast factors:
landing and/or take-off demand;
available landing and/or take-off capacities of each usable landing and/or take-off runway;
taxi route from the landing runway to the parking position and/or from the parking position to the take-off runway;
taxiing costs for the taxi route.

The determination of the optimum landing and/or take-off runway permits a better exploitation of the available capacities, an increase in traffic flow and punctuality and a reduction of taxiing traffic costs. The taxiing process can be calculated or forecast more accurately. At the same time, this optimization results in a minimization of ground noise and of the emissions caused by taxiing traffic and waiting times with the engines running.

In continuation of this aspect of the invention, the determined landing and/or take-off runway is transmitted to Air Traffic Control of the airport. So far, only position-dependent inquiries for a particular landing runway and no requests at all for a take-off runway have been transmitted to Air Traffic Control.

According to a second aspect of the invention, the duration of at least one of the following partial processes of the flight visit limited by defined process times is calculated having regard to actual or forecast factors:
approach, limited by the time of flying over the entry fix (TOF) and the time of landing (ATA);
taxi inbound, limited by the time of landing (ATA) and the on-blocks time (ONB);
taxi outbound, limited by the off-blocks time (OFB) and the time of take-off (ATD);
departure, limited by the time of take-off (ATD) and the time of flying over the departure fix (ATDF).

This allows a more accurate forecast of the estimated process times.

For example, the duration of the “approach” partial process can be calculated having regard to at least one of the following actual or forecast factors:
volume of inbound traffic;
approach route;
landing runway;
wind/weather conditions.

The duration of the “taxi inbound” partial process is preferably calculated having regard to at least one of the following actual or forecast factors:
landing runway;
parking position;
volume of taxiing traffic;
wind/weather conditions;
taxi route from the landing runway to the parking position;
runway/taxiway intersections;
type of aircraft.

For the calculation of the duration of the “taxi outbound” partial process, provision is made to include at least one of the following actual or forecast factors:
parking position;
take-off runway;
volume of taxiing traffic;
wind/weather conditions;
taxi route from the parking position to the take-off runway;
runway/taxiway intersections;
type of aircraft.

Just as for the determination of the optimum landing or take-off runway, in the two partial processes “taxi inbound” and “taxi outbound” the environmental burden and noise exposure may be distinctly lowered by the process optimization according to the invention.

Finally, the duration of the “departure” partial process can be calculated having regard to at least one of the following actual or forecast factors:
volume of outbound traffic;
departure route;
take-off runway;
wind/weather conditions.

A further development of the second aspect of the invention provides that at least one estimated process time of the flight visit is calculated including at least one previously calculated duration of a partial process. In this way, the more accurate calculation/forecast of the arrival times allows the handling processes at the airport to be planned better and the required resources (staff and equipment) to be employed more economically.

Specifically, at least one of the following process times is to be calculated:
estimated time of flying over the entry fix (ETOF);
estimated time of landing (ETA);
estimated on-blocks time (EONB);
estimated off-blocks time (EOFB);
estimated time of take-off (ETD);
estimated time of flying over the departure fix (ETDF).

A more extensive optimization of the air traffic management may be achieved in that at least one target process time of the flight visit is calculated having regard to at least one previously calculated duration of a partial process. By taking into account lags to be expected in particular partial processes at the airport, measures can be taken at an early point in time in order to compensate for these lags by adhering to the calculated target process times.

By transmitting the calculated target process times to Air Traffic Control of the airport, Air Traffic Control can prioritize the approaching flights in accordance with the target process times, with the aim to increase the punctuality rate of the arriving traffic.

Of particular importance for this are the target time of flying over the entry fix (TTOF) and the target time of landing (TTA).

An early knowledge of an estimated delay allows countermeasures to be taken in good time to avoid it. In this connection, the invention proposes calculating for a flight visit the estimated delay for at least one defined process time having regard to at least one calculated estimated process time and the corresponding calculated target process time. In addition, this allows causes of delays, in particular “externally” caused delays (brought along delays), to be identified.

Preferably, the calculations of the method according to the invention are carried out dynamically. This means that the calculations are updated as soon as more current input data (more recent forecasts or actually measured values) are available.

For a visual reproduction of relevant information in connection with the optimized air traffic management, the invention provides an information system including an electronic data processing system which executes a computer program which is used to determine and/or calculate at least one of the following items of information using the results of the method according to the invention, and including a screen for display of the information:
overview of the utilization of the available take-off and landing runways;
overview of the target process times, the estimated process times, and the actual process times of a flight visit;
indication of the delays for each partial process of a flight visit;
overview of the entire volume of traffic at the airport as related to the partial processes of the flight visits in specific time intervals;
overview of the average delays as related to the partial processes or the process times of the flight visits in specific time intervals;
overview of the average lags as related to the partial processes or the process times of the flight visits in specific time intervals;
overview of the delays in the ground handling of the flight visits.

Further details of the present invention will become apparent from the following description with reference to the accompanying drawings, in which:

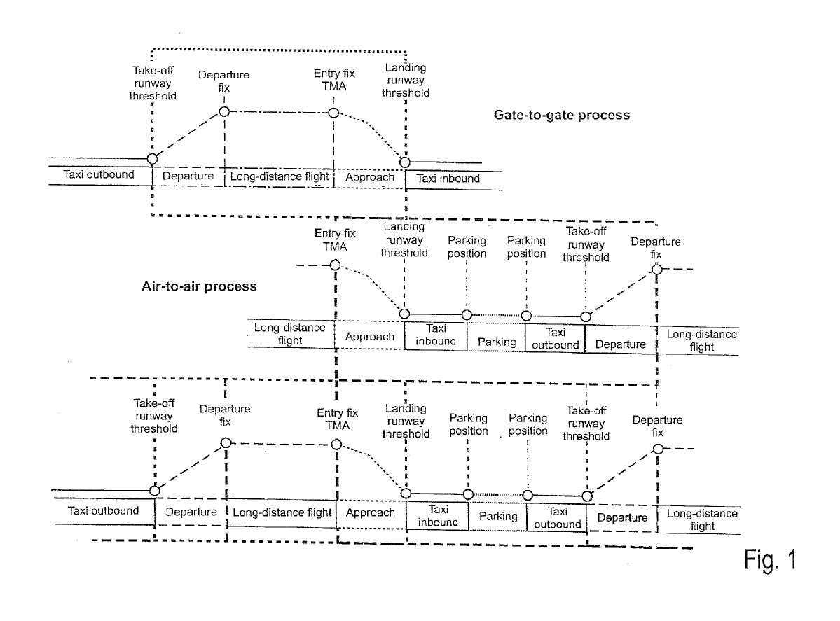

FIG. 1 shows a networking of the gate-to-gate process and the air-to-air process;

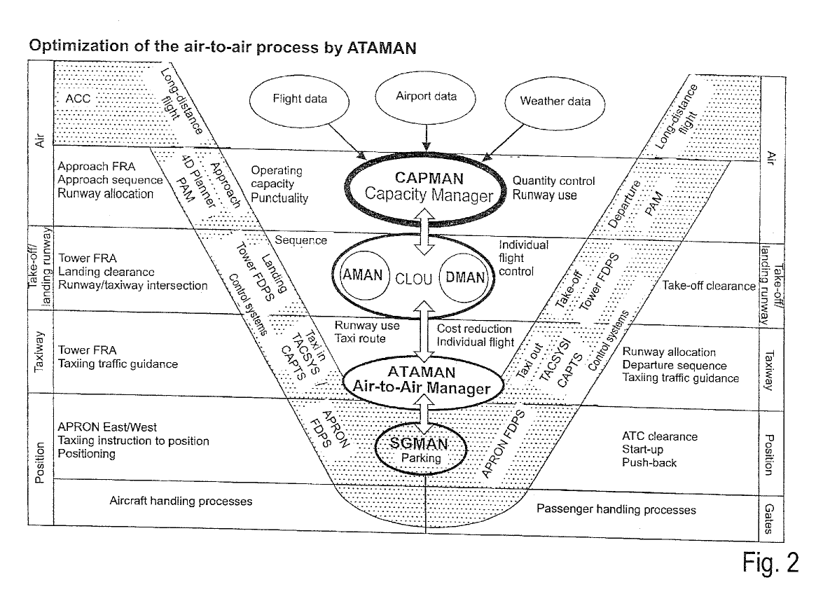

FIG. 2 shows an incorporation of the Air-to-Air Process Manager ATAMAN into the existing system landscape;

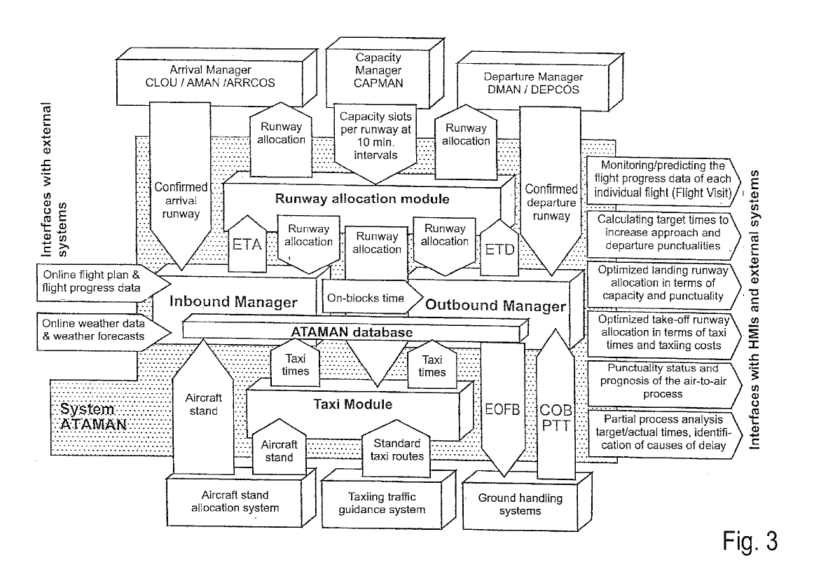

FIG. 3 shows the technical concept of ATAMAN;

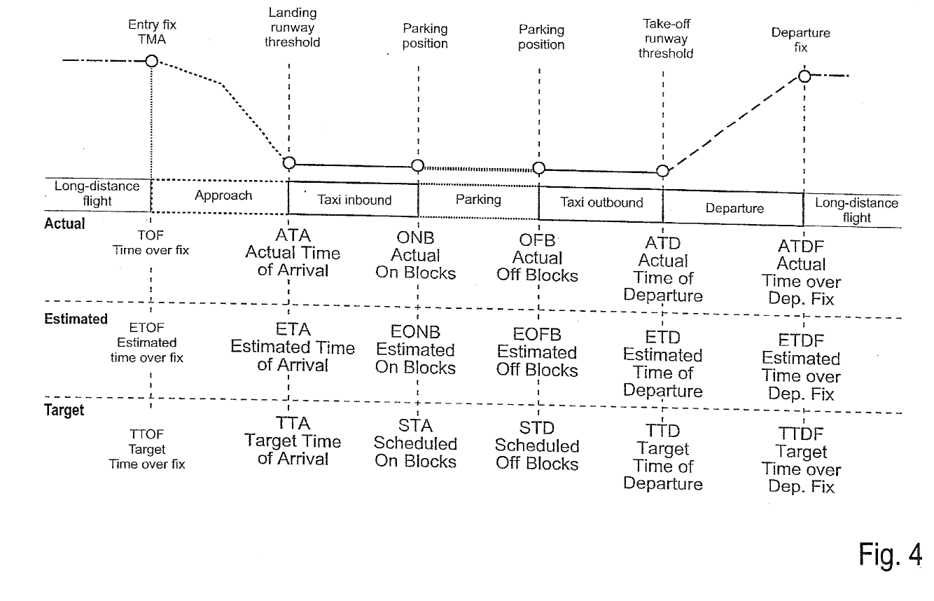

FIG. 4 shows a flight visit;

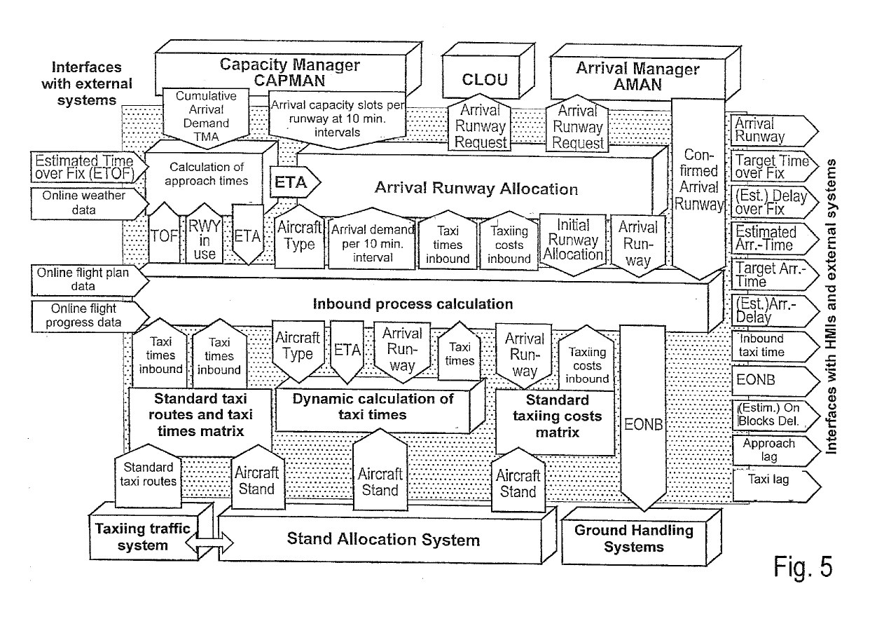

FIG. 5 shows an inbound data processing;

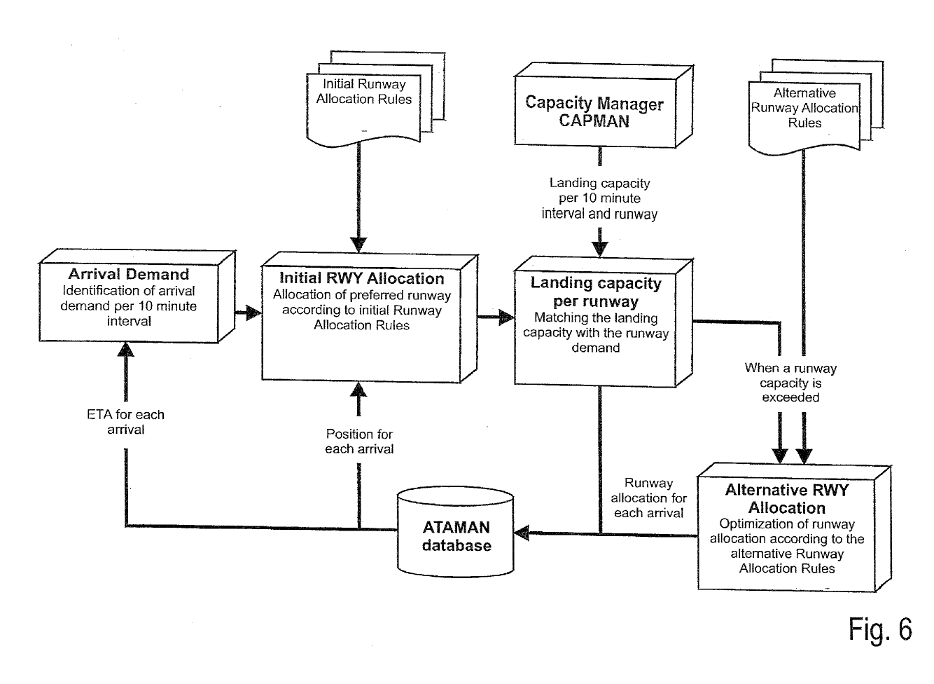

FIG. 6 shows a landing runway allocation;

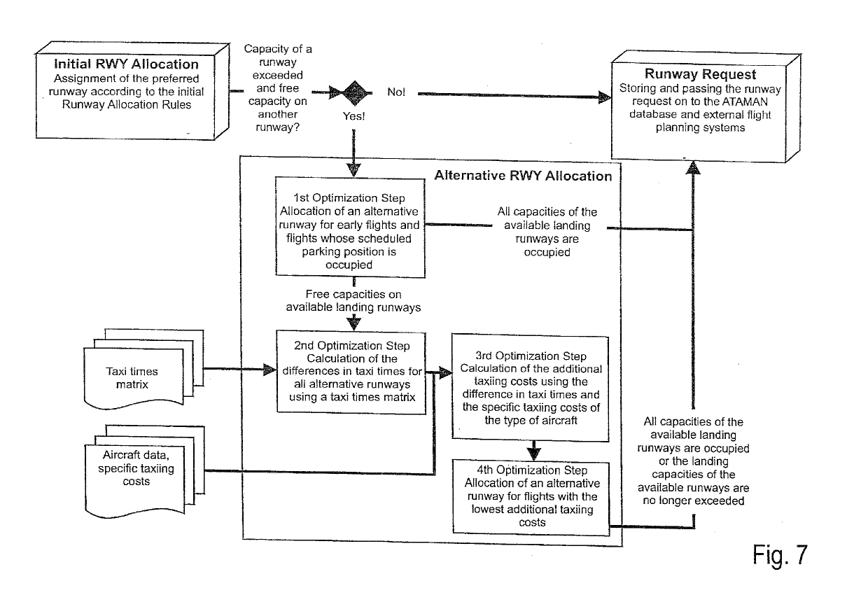

FIG. 7 shows a landing runway allocation process;

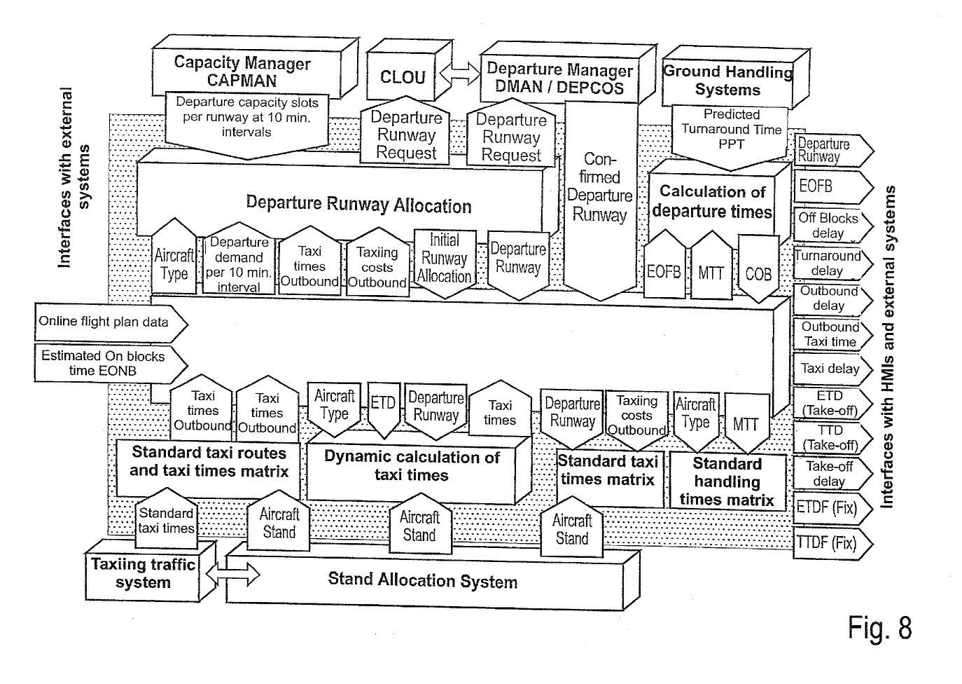

FIG. 8 shows an outbound data processing;

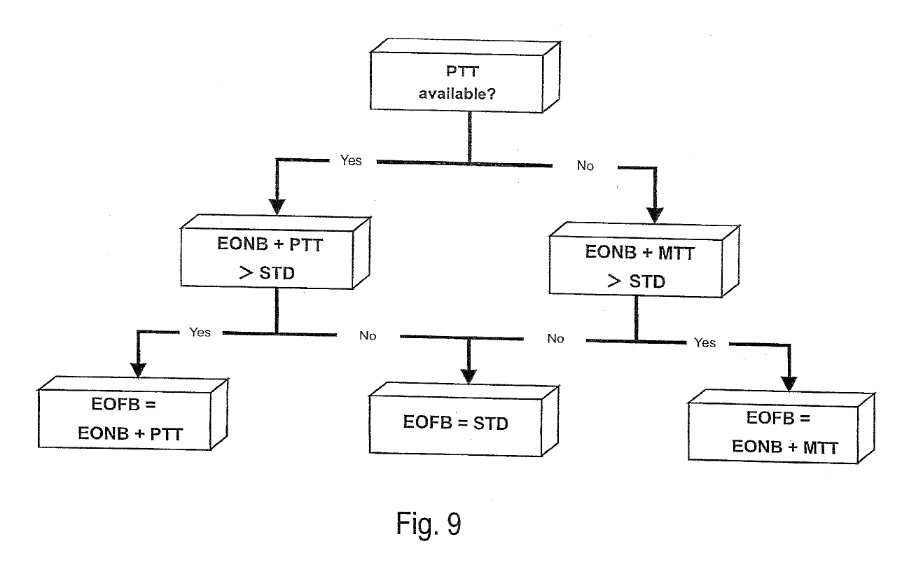

FIG. 9 shows a calculation of the estimated off-blocks time EOFB;

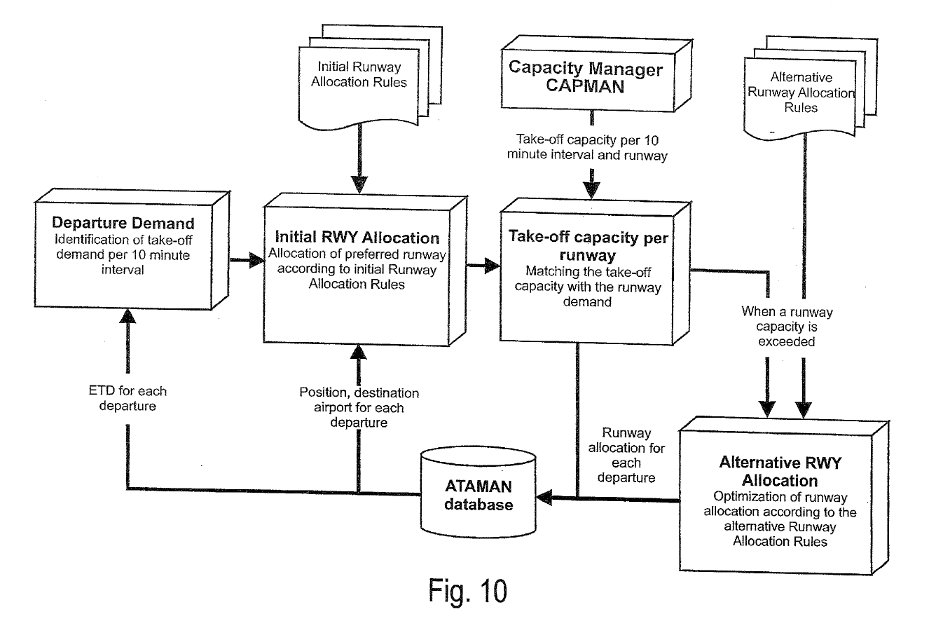

FIG. 10 shows a take-off runway allocation;

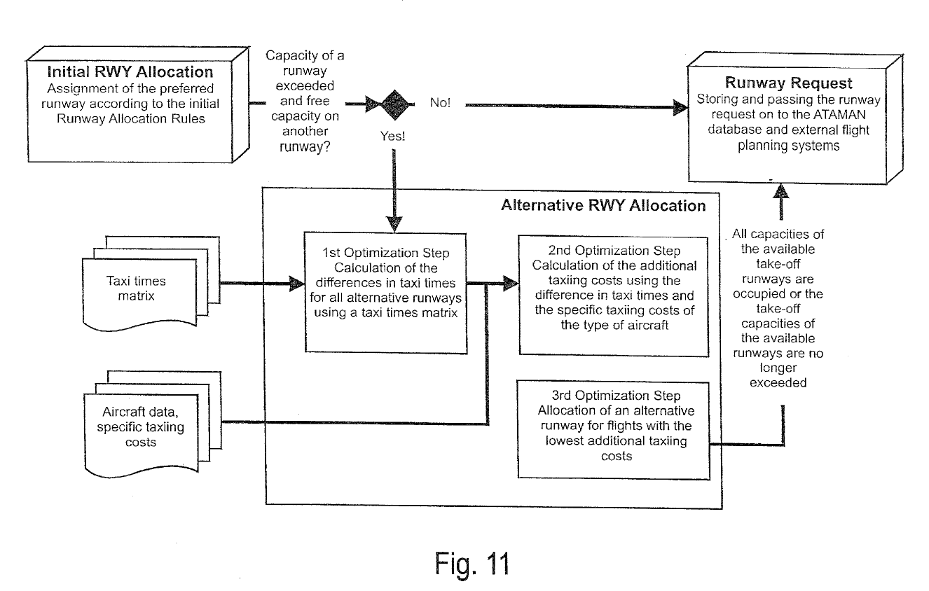

FIG. 11 shows a take-off runway allocation process;

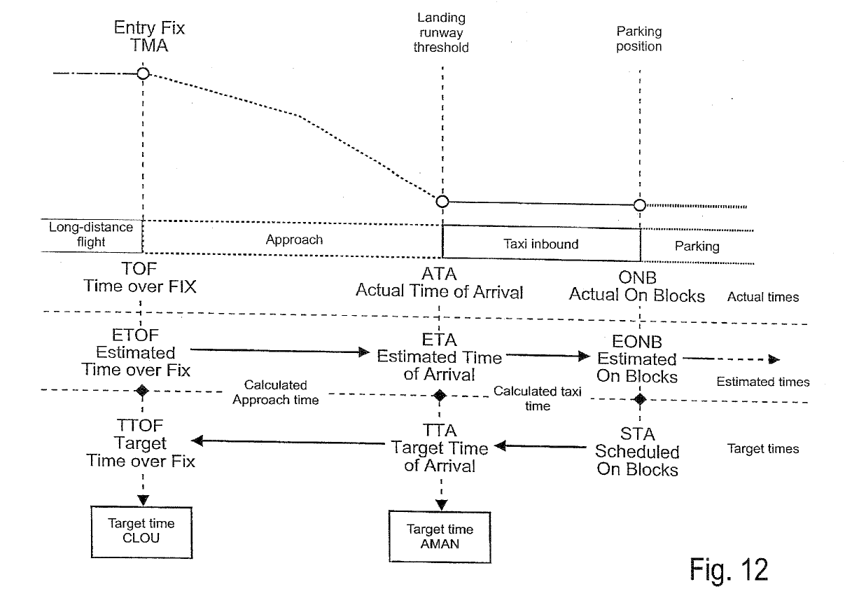

FIG. 12 shows inbound process and control data;

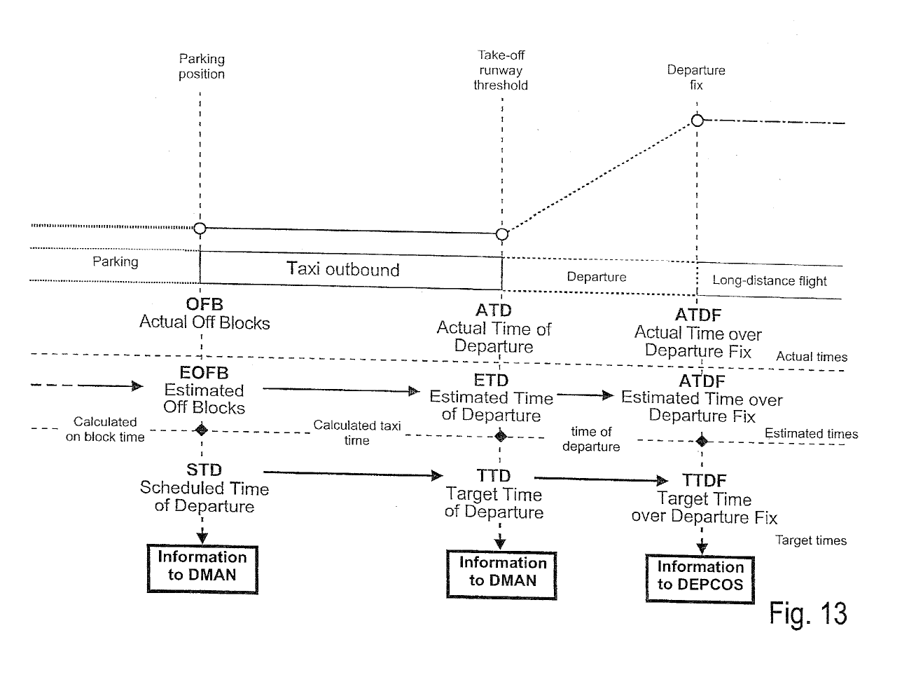

FIG. 13 shows outbound process and control data;

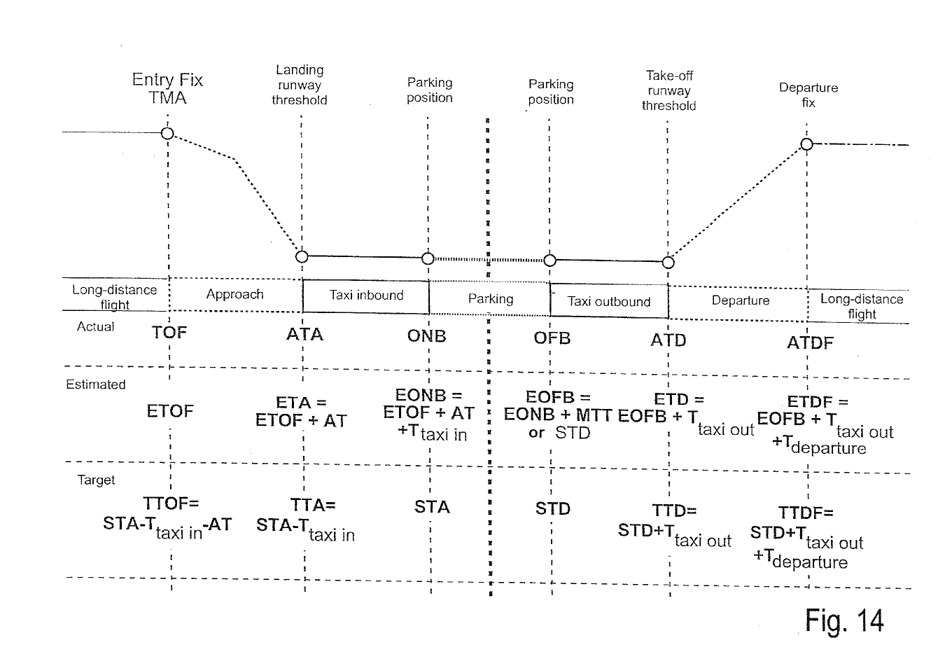

FIG. 14 shows an air-to-air process data calculation;

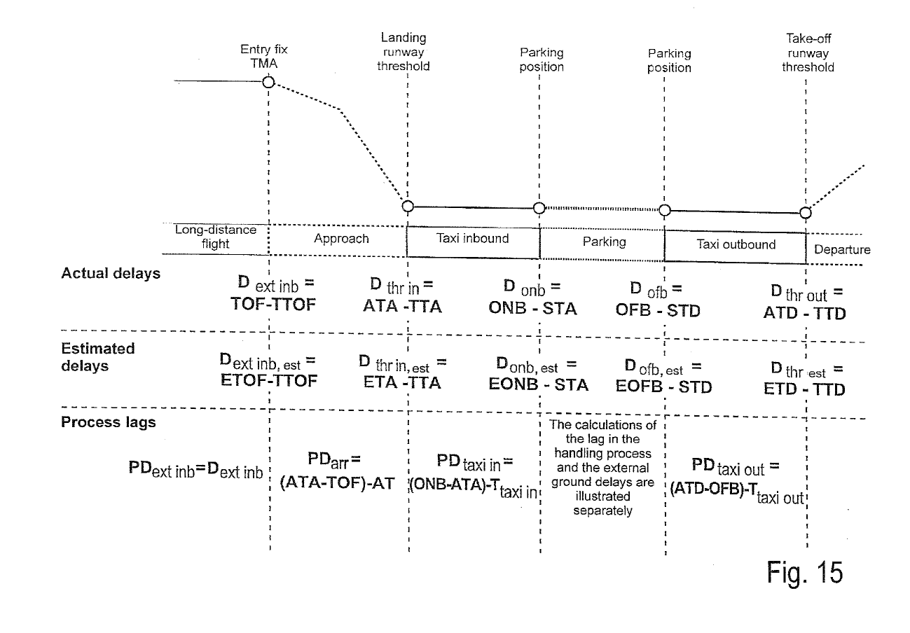

FIG. 15 shows delays and process lags;

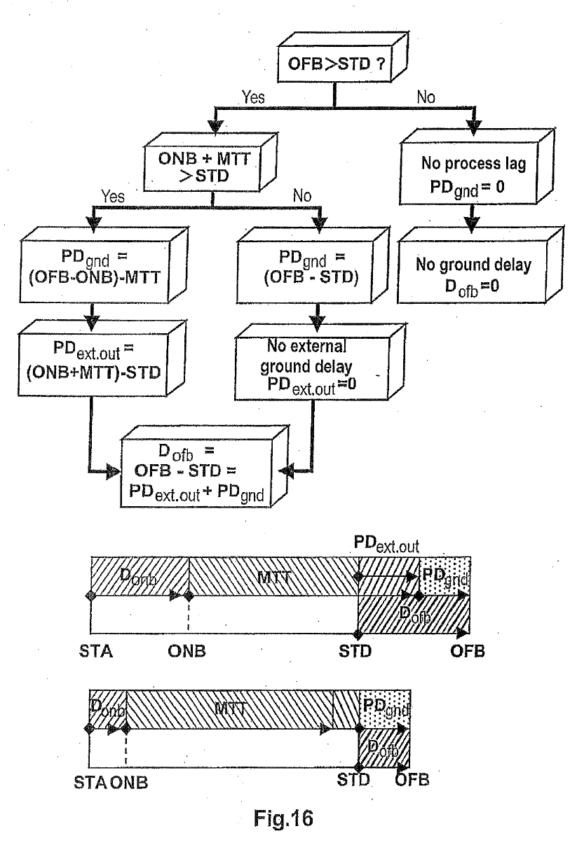

FIG. 16 shows a calculation of the handling and servicing delays;

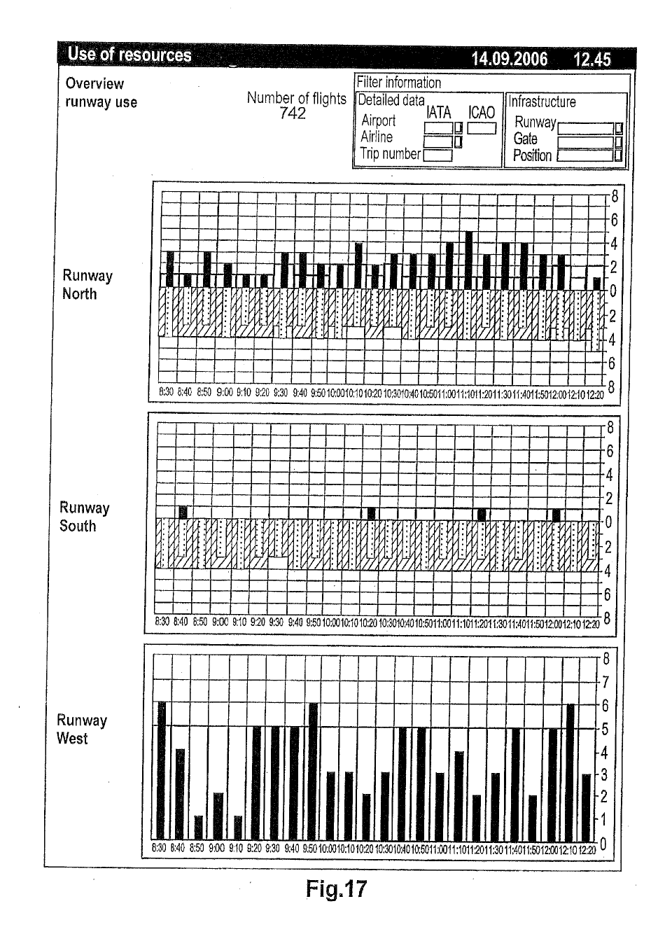

FIG. 17 shows the ATAMAN user surface: take-off/landing runway utilization, using the Frankfurt Airport as an example;

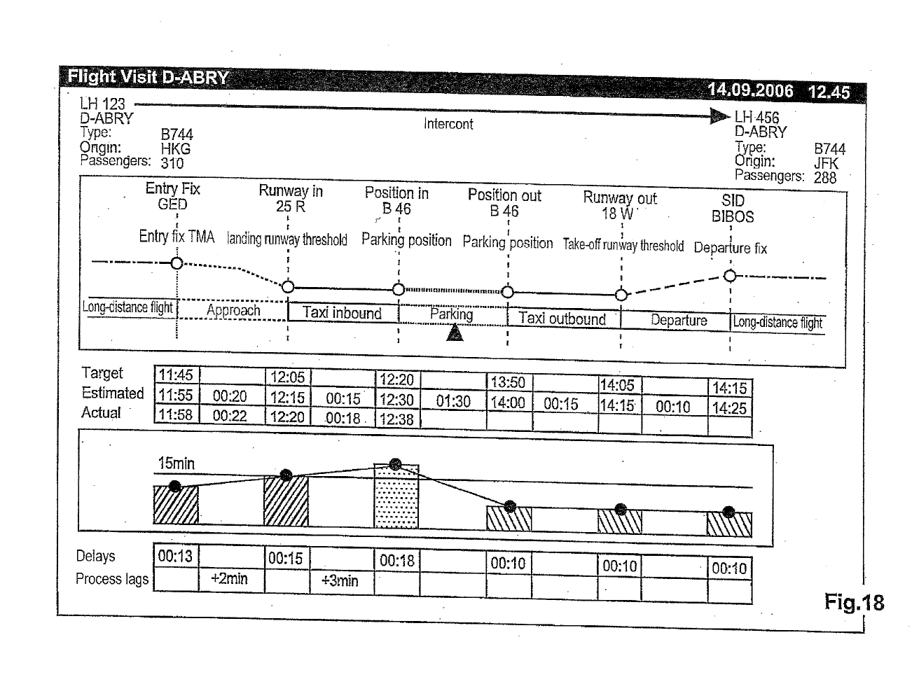

FIG. 18 shows the ATAMAN user surface: flight visit;

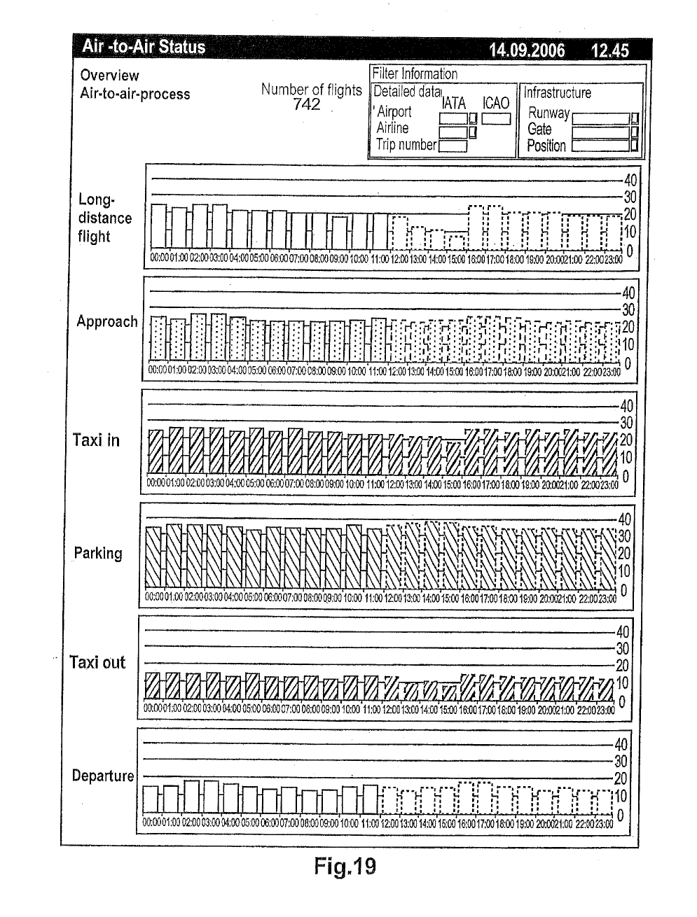

FIG. 19 shows the ATAMAN user surface: traffic volume in the air-to-air process;

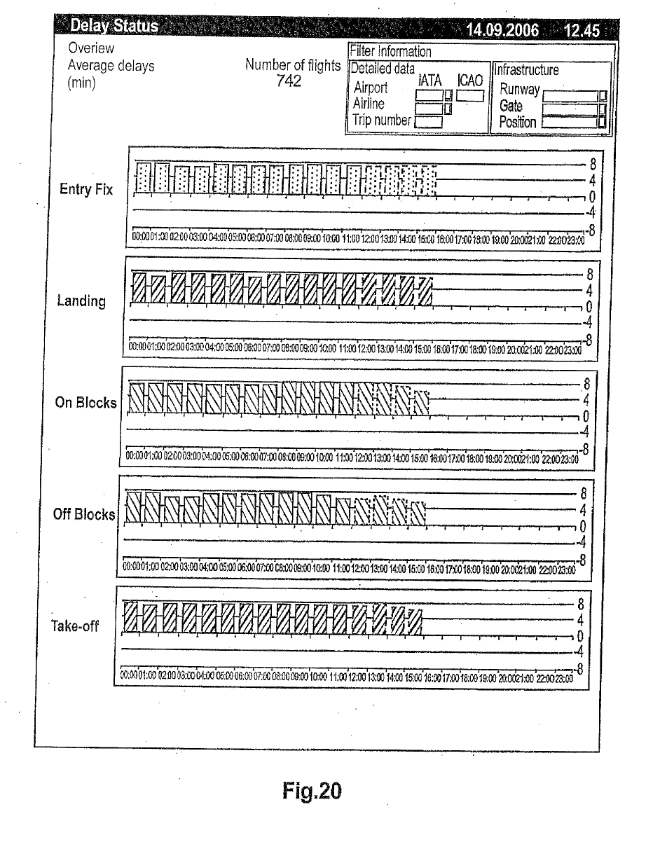

FIG. 20 shows the ATAMAN user surface: delays in the air-to-air process;

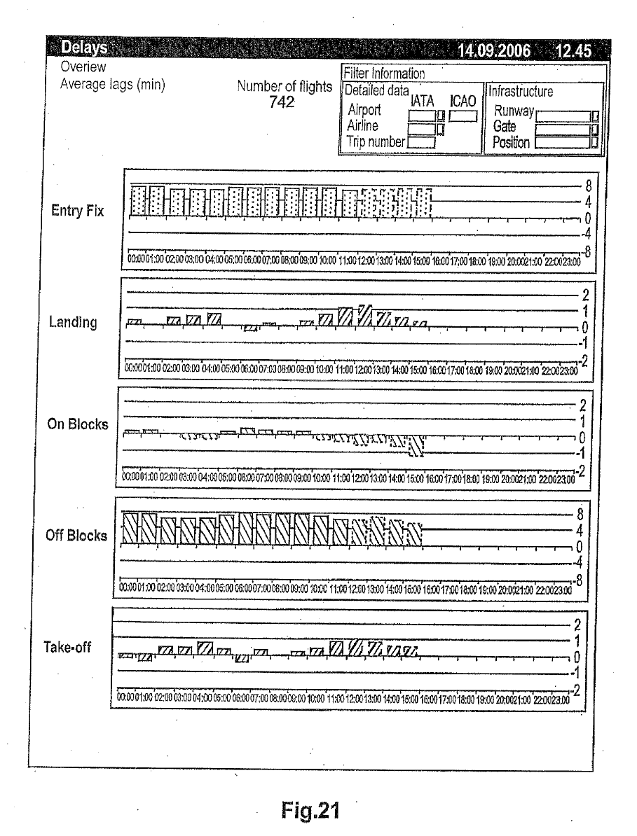

FIG. 21 shows the ATAMAN user surface: lags in the air-to-air process; and

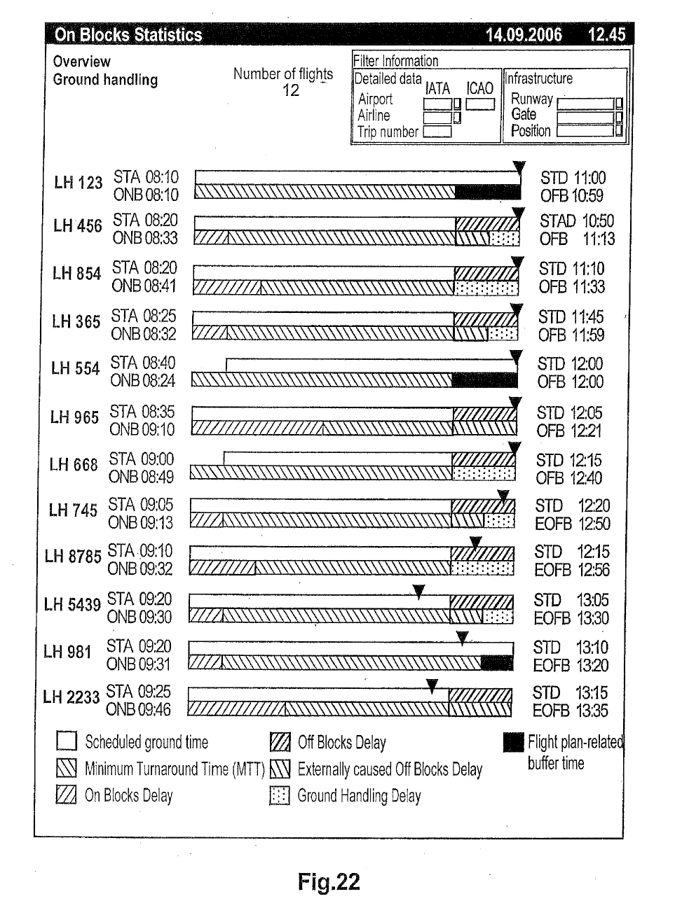

FIG. 22 shows the ATAMAN user surface: ground delays in the air-to-air process.

A multitude of partners, such as, e.g., airlines, Air Traffic Controls, airport operators, and handling and servicing agents are involved in the management of air traffic at an airport. Up to now, the partners involved have optimized their partial processes in managing the air traffic without a superordinate process consideration and without an integration of the air traffic carriers involved. For the following description, the term “flight visit” is to be understood as the sum of all partial processes (approach, taxi inbound, parking, taxi outbound, and departure) in a visit of an individual aircraft at an airport between two long-distance flights.

Air Traffic Control controls the long-distance flights in the airspace and coordinates them in accordance with the available airspace capacities. Computer-aided arrival and departure managers and coordination systems (e.g., AMAN, DMAN, DEPCOS) are increasingly made use of at the airports in order to integrate the arrivals and departures from and to the airports in the so-called gate-to-gate process defined in FIG. 1. On the whole, i.e. with a view to the overall air traffic management process at the airport, which is likewise defined in FIG. 1 and is referred to as air-to-air process below, an airport operator still needs to deal with non-coordinated ends of two gate-to-gate processes.

A marked improvement in the air traffic management, in particular with a view to the punctuality of the air traffic as the volume of traffic rises, is achieved according to the invention by a comprehensive process consideration, i.e. by coupling the gate-to-gate process with the air-to-air process in an integrated network system. A technical aid for this is primarily a computer-based process manager which is referred to as ATAMAN (Air-to-Air Process Manager) below.

For an automatic optimization of the air-to-air process, ATAMAN may be networked with the Capacity Manager CAPMAN described in German Patent Application 10 2007 009 005.8 and the tactical systems for traffic control of Air Traffic Control (e.g., CLOU, AMAN, DEPCOS) and apron control (DMAN, SGMAN). The incorporation of ATAMAN into the system landscape existing at the Frankfurt Airport is illustrated in FIG. 2. The basic concept of ATAMAN, the structure, the cooperation with other systems, and the human-machine interfaces (HMI) and the interfaces to external systems are apparent from FIG. 3.

The technical concept of ATAMAN permits the following types of use:
use as an information system for the detailed representation of the air-to-air process of each individual flight (flight visit) and for the identification of causes of delays;
use as an information system for the superordinate representation of the traffic load in the TMA (terminal maneuvering area) and in the taxiway system;
use as a control system for the allocation, optimized in terms of capacity and punctuality, of a defined take-off and/or landing runway for each individual flight;
use as a part of a superordinate traffic control system (Air Traffic Control/airport) by automatically passing the ATAMAN results on to existing flight guidance systems (e.g., AMAN/DMAN).

ATAMAN optimizes the air-to-air process in its entirety, with the sum of all flight visits being considered in a defined time interval at the airport. As can be seen from FIG. 4, a flight visit is subdivided into five partial processes: approach, taxi inbound, parking, taxi outbound, and departure. Process lags may appear in each partial process and, according to the invention, are specifically calculated and/or forecast.

For calculating and forecasting these lags, for each arriving flight at first the estimated flight progress times illustrated sub “Estimated” in FIG. 4 and the target times illustrated sub “Target” therebelow are calculated. The calculation of the estimated flight progress times is based on the estimated time of overflight of the entry fix ETOF, which is reported following take-off from the previous airport. Using a specially developed formula for calculating the approach time, the estimated time of landing ETA is calculated. The taxi module of ATAMAN calculates from the estimated time of landing ETA the estimated on-blocks time EONB (reaching the parking position), taking into consideration the traffic load in the taxiing area. The estimated off-blocks time EOFB (leaving the parking position) is calculated from the estimated on-blocks time EONB and the minimum turnaround time MTT of the aircraft and taking into consideration the target off-blocks time STD. The estimated time of take-off ETD is calculated from the estimated off-blocks time EOFB and the taxiing time as calculated by the taxi module. Finally, the estimated time of overflight of the departure fix ETDF is calculated from the estimated time of take-off ETD and the time of departure, which is dependent on the take-off threshold and the departure route.

The inbound target times TTA (target time of landing) and TTOF (target time of overflight of the entry fix) are calculated from the published flight plan arrival time STA (scheduled on-blocks) and the above-mentioned taxi and approach times; the outbound target times TTD (target time of take-off) and TTDF (target time of overflight of the departure fix) are correspondingly calculated from the published flight plan departure time STD (scheduled off-blocks).

The forecast delay minutes are calculated as a difference between the estimated times and the target times. The actual delay minutes are calculated from the measured actual times and the target times. The differences obtained from the estimated times and the actual times provide information about additional lags in each partial process. Frequently, however, delays already arise at the previous airport or on the flight route and are brought along to the airport. These “external” delays are calculated as differences from (E)TOF and TTOF.

The above time calculations and the measures made possible thereby for optimizing the air traffic management at an airport will now be discussed in more detail below.

Optimization of the Inbound Process

Establishing the inbound process involves a cooperation of the Inbound Manager, the runway allocation module and the taxi module. For the purpose of simplification, reference is made to the Inbound Manager below. The Inbound Manager optimizes the inbound portion of the air-to-air process, taking into account the
overall traffic demand (inbound and outbound demand);
operating capacity of the take-off/landing runway system, arrival and departure capacity;
weather and weather forecasts;
flight plan data;
flight progress data (departure messages, TOF (time over fix));
parking position of the aircraft;
standard inbound taxi routes, and calculates for each of the aircraft arriving within the next few hours
the estimated approach time between entry fix and landing threshold;
the estimated time of landing;
the optimum runway, taking into consideration the departures occurring concurrently;
the expected taxi time between the landing threshold and the parking position;
the estimated time of arrival on this position.

The calculation and forecast of the optimum landing runway and the forecast flight progress data is made possible by a special calculation algorithm.

FIG. 5 illustrates the mode of operation of the Inbound Manager and its support modules.

For calculating and forecasting the inbound process and for an optimized runway planning and scheduling, the Inbound Manager, in addition to flight plan data, continually requires actual data on flights already departed from the previous airport, on the “runways in use” (designates the current operational direction of the take-off/landing runways, which is determined by the wind direction) and on the weather and as precise weather forecasts as possible. In addition, capacity data of the landing runway system and information on the planned parking positions are required. External data sources are constituted by the airport information system, the Capacity Manager CAPMAN, the stand allocation system, air traffic control systems, and the weather information system of the meteorological service. For an online data supply, provision is made for data interfaces with these systems.

In the following, the calculation of the approach time, the allocation of a landing runway, and the calculation of the taxi inbound time will be described in detail.

The approach time—this is the period of time required by an arriving aircraft from entry into the airspace of the airport (flying over the entry fix) up to landing (touchdown)—essentially varies with the number of approaching aircraft (arrival demand) in the airspace of the airport (TMA, terminal maneuvering area), with the visibility conditions and the cloud base, with the wind conditions and temperature, as well as the “runway in use” and the standard arrival route (STAR).

The approach times calculating module of the Inbound Manager calculates the estimated approach time for each flight taking into account relevant influential factors. The estimated time of landing ETA is calculated from the forecast TOF (time over fix), which it receives from the previous airport along with the departure message, and the approach time calculated individually for each approach. The expected time of landing ETA is, on the one hand, an essential time mark for the individual flight visit and, on the other hand, constitutes an important criterion for decisions relating to the superordinate air-to-air process from the airport point of view. At this point in time, the airport needs to provide the resource for landing (landing slot) to avoid lags in the traffic flow.

The arrival demand has a decisive influence on the approach time of each approaching flight. When the arrival demand is low, the arriving flight is assigned a direct flight route from the entry fix to the landing threshold involving a correspondingly short flight time, whereas a high arrival demand results in the formation of an “approach queue” involving long approach times. The cumulative arrival demand of the preceding time interval, which is relevant to forecasting the approach time of an incoming flight, has already been calculated by the Capacity Manager CAPMAN and is transmitted to the Inbound Manager (approach times calculating module).

The weather has a great influence on the flow (traffic throughput), in particular in the inbound traffic. A low flow will lengthen the waiting queue and delay the processing of the arrival demand, as a result of which the approach time for incoming flights is prolonged. The visibility and cloud base (VMC/MMC/IMC) quite substantially determine the approach separation; the wind and the temperature have effects on the approach speed above ground.

To forecast the approach times AT, an approach times calculating model was developed which takes the relevant influencing factors into consideration. The following formula is representative of the Frankfurt Airport and may be adjusted to fit any other airport.

$$A T = A {T}_{0} + A {T}_{Temp}$$

$$A {T}_{0} = A {T}_{Min} + A {T}_{Mov} + A {T}_{Wind} + A {T}_{RWY}$$

$$A {T}_{0} [ ( \begin{matrix}V M C \\ M M C \\ I M C\end{matrix} ) , F B , {v}_{Wind} , R W Y ] = \{ 8 \} + \{ \frac{1}{2 π} \cdot \frac{256}{{( FB - [ \begin{matrix}40 \\ 39 \\ 38\end{matrix} ] )}^{2} + 64} \cdot [ \begin{matrix}8 \\ 11 \\ 14\end{matrix} ] \} + \{ \frac{1}{6} \cdot [ ( {v}_{Wind} - 6 ) ] \cdot [ 1 + tanh ( {v}_{Wind} - 6 ) ] \} + \{ \begin{matrix}{0}_{[ 25 ]} \\ {3}_{[ 07 ]}\end{matrix} \}$$

$$A {T}_{Temp} ( {t}_{[ ° C . ]} ) = - [ 0 , 0017331352 \cdot {t}_{[ ° C . ]} + 0 , 029433047 ] \cdot {AT}_{0}$$

$${v}_{wind} \text{:} wind velocity$$

$$F B \text{:} traffic volume$$

The estimated time of flying over the entry fix ETOF is the result of the flight calculation of each flight as of its time of take-off from the previous airport and contains all information for the flight that is known at the time of take-off, such as, e.g., flight route, wind/weather conditions, aircraft altitude and speed. The ETOF is therefore a very reliable forecast flight progress datum. It is transmitted along with the departure message. In case the time ETOF is not yet available for a period of time to be forecast because, e.g., the flight has not yet departed, the time TOF is calculated from the flight plan arrival time STA as follows:

ETOF=STA−T_{Def Taxi In}−T_{Def Approach} (Example FRA: ETOF=STA−20 min)

When the arriving aircraft flies over the entry fix, the time TOF is acquired and the datum ETOF is replaced.

The estimated time of landing ETA is calculated from the (E)TOF and the forecast approach time:

ETA=(E)TOF+AT

The estimated time of landing ETA marks the transition from the inbound partial process “approach” to the “landing and taxiing process”. The differentiation of the partial processes serves to attribute the delays to the respective causes, among other purposes.

The Inbound Manager optimizes the landing runway allocation for all approaching flights within each 10-minute interval (see FIG. 6) according to the following criteria:
reduction of the approach delays/approach delay costs by making the best possible use of the available landing capacities (calculated by CARMAN);
minimization of the taxi times (and spacing out the taxiing traffic) by parking position-dependent (initial) runway allocation;
reduction in the taxiing costs by a cost-optimized alternative runway allocation,

and transmits its runway allocation to the relevant air traffic control systems (e.g., CLOU, AMAN).

The Inbound Manager determines the landing demand for each 10-minute interval on the basis of the expected times of landing as calculated by the approach times calculating model. The sum of all approaching flights whose estimated times of landing fall within a fixed 10-minute interval constitutes the respective landing demand which has to be handled using the available landing runways.

The landing runway allocation is effected in several steps, each of which is illustrated in FIG. 7. In accordance with the valid rules, at first each flight is assigned the runway with the shortest taxi route to the intended parking position as the preferred landing runway. The allocation is performed based on a table stored in the ATAMAN database, which assigns a landing runway to each approaching flight on the basis of its parking position. This initial runway allocation is essentially geared to the shortest possible taxi routes and, if applicable, also to bypassing taxiing traffic junction points to avoid taxiing lags. With the initial runway allocation the landing demand/10 min for each landing runway is defined at the same time.

The Inbound Manager now checks whether the landing demand for each runway can be satisfied by the respective landing runway capacity. If this is the case, each approaching flight is allocated its preferred landing runway. The Inbound Manager receives the respective landing runway capacity from the Capacity Manager CAPMAN.

When the landing demand exceeds the landing capacity of the preferred runway, the Inbound Manager checks whether free landing capacity is available on an alternative runway in the same 10-minute interval, in order to avoid approach lags. In case of free capacities on an alternative runway, the Inbound Manager will propose the alternative runway for use.

As a rule, one or more flights of a 10-minute interval need to be rescheduled from their preferred landing runway to an alternative one for reasons of capacity, with the negative consequence for the flights concerned that their taxi route and thus their taxi time is prolonged and taxiing costs increase.

The Inbound Manager performs the rescheduling processes according to defined optimization criteria. To minimize delays in case of capacity bottlenecks, in a first optimization step early flights and flights whose parking position is still occupied are assigned the alternative landing runway. If, in addition to this, still further flights need to be rescheduled due to a landing capacity bottleneck that continues to exist, in a second optimization step the Inbound Manager determines the difference in taxi times for each flight that is up for scheduling and, in doing so, accesses tables containing stored taxi times. In the third optimization step, the Inbound Manager calculates the additional taxiing costs for each taxi time difference, taking into account the type of aircraft (twin-jet, tri-jet, four-jet type of aircraft). In the fourth optimization step, the alternative landing runway is allocated to the flight involving the respectively lowest increase in taxiing costs.

The Inbound Manager reschedules until the landing demand for the preferred landing runway no longer exceeds the landing capacity thereof or until the landing capacity of the alternative landing runway is exhausted.

The optimization of the landing runway allocation is completed and the Inbound Manager transmits its runway allocation (arrival runway request) to the relevant air traffic control systems (e.g., CLOU, AMAN). Since Air Traffic Control has the responsibility for carrying out the flight, it can adopt or change the proposed landing runway allocation. The Inbound Manager adopts any changes made by Air Traffic Control. The landing runway allocated by Air Traffic Control must not be changed by ATAMAN.

Once the landing runway for the approaching flight has been established, the Inbound Manager can calculate the expected taxi time from the landing threshold up to the parking position with the aid of the taxi times model individually for each individual arrival. The taxi times calculating module calculates the period of time required by a landing aircraft from touchdown to the parking position. To calculate the expected landing runway occupancy time, the type of aircraft is needed in order to derive the required landing distance from the typical touchdown speed. In addition to the landing runway occupancy time, the expected runway exit marking the beginning of the inbound taxi route is also calculated. To calculate the inbound taxi times, the Inbound Manager requires the runway exit and the parking position. The distance is defined by defined standard taxi routes. The parking position intended for the arriving flight is provided to the Inbound Manager by the aircraft stand allocation system. This information may possibly be obtained also via the airport information system of the airport.

As a rule, every airport has defined so-called standard taxi routes (inbound and outbound). The standard taxi routes mostly constitute the shortest taxi route between the runway exit and the parking position or between the parking position and the take-off threshold, avoiding oncoming traffic to the greatest possible extent and, where possible in terms of locality, also avoid taxiing traffic junction points. The taxiing traffic is basically handled via these standard taxi routes. The taxi times calculation therefore takes them as a basis in the individual taxi times calculation. Since other flight operating systems (e.g., DMAN) also need to process information about taxi times, standard taxi times are defined, which are to be expected in case of typical traffic volumes. These standard taxi times usually relate to position regions and are of an accuracy sufficient for most applications. In the alternative landing runway allocation (second optimization step) the difference between these standard taxi times of the preferred landing runway and all alternative landing runways is calculated and, as described above, taken into consideration.

To forecast the air-to-air process, an as exact taxi times forecast as possible is required. In calculating the time T_{Taxi In} required for the distance between the runway exit and the parking position, the taxi times calculating module takes into account both differentiated taxiing speeds for different taxiway sections (e.g., curves, straight lines, intersections) and also possible taxiing hindrances caused by other aircraft (taxiing load: number of taxiing aircraft in the taxiway system) as well as take-off/landing runway intersections, where necessary. All relevant information about the taxiway system and typical taxiing speeds are stored in the taxi times calculating module; the actual and forecast taxiing load is calculated in each case.

The expected time of arrival on the parking position EONB is calculated from the estimated time of landing ETA and the forecast inbound taxi time T_{Taxi Inb}:

EONS=ETA+T_{Taxi Inb}

Owing to the factors influencing the approach and taxi times mentioned above and taken into consideration, the calculated time EONB is very accurate and therefore a valuable control datum for the beginning of the ground processes. It is of great importance to the punctual and economic aircraft handling to know the expected time of arrival of each individual flight visit at an early point in time and as exactly as possible.

The calculation of the expected time of arrival on the parking position EONB concludes the inbound process and at the same time marks the beginning of the outbound process, which is intended to ensure a punctual take-off.

Optimization of the Outbound Process

In determining the outbound process, the Outbound Manager, the Runway Allocation Module, and the Taxi Module cooperate. For simplification purposes, reference is made to the Outbound Manager below. The Outbound Manager optimizes the outbound part of the air-to-air process, taking into consideration the
operating capacity of the take-off/landing runway system, arrival and departure capacities;
standard instrument departure routes (SID);
flight plan data (STD);
flight progress data (ETD, EOFB);
parking position of the aircraft;
standard outbound taxi routes;
taxi times,
   and calculates for each of the aircraft departing within the next few hours
the optimum take-off runway taking into consideration the flights arriving concurrently;
the earliest off-blocks time;
the estimated taxi time between the parking position and the take-off threshold;
the estimated time of arrival at the threshold.

The calculation and forecast of the optimum take-off runway and the forecast flight progress data is made possible by a special calculation algorithm.

FIG. 8 illustrates the mode of operation of the Outbound Manager and its support modules.

For calculating and forecasting the outbound process and for an optimized take-off runway planning and scheduling, the Outbound Manager, in addition to flight plan data, constantly uses current data relating to the earliest possible off-blocks time from the ground handling systems of the aircraft handling agents (PTT=predicted turnaround time), the “runways in use” as well as capacity data of the take-off runway system and information on the planned departure routes. The airport information system, the Capacity Manager CAPMAN, ground handling systems, and air traffic control systems are external data sources. For an online data supply, provision is made for data interfaces with these systems.

The calculation of the estimated off-blocks time, the allocation of a take-off runway, the calculation of the taxi outbound time and of the time of departure will be described in detail below.

The Outbound Manager receives, via an ATAMAN-internal interface, the actual and forecast data on incoming flights on the parking position to calculate the earliest possible off-blocks time, taking into consideration the minimum turnaround time (MTT) for the aircraft involved or for the flight involved. For the calculation of the estimated off-blocks time by the Outbound Manager, three cases are under review according to the rule illustrated in FIG. 9.

The earliest off-blocks time initially corresponds to the scheduled time of take-off STD, since the EOFB time can never be earlier than the STD time.

EOFB=STD

In case of delayed arrivals and tightly scheduled regular ground times of a flight visit, departure delays may materialize which are due to arrival delays:

EOFB=EONB+MTT

Lags in ground handling of the flight may likewise result in departure delays. The causes for this may reside in a variety of processes such as, e.g., in the aircraft handling and servicing process (loading, fueling, catering, etc.) or in the passenger handling process (check-in, security screenings, boarding, etc.). When such lags or other changes occur, the Outbound Manager requires the respective information from the corresponding ground handling systems or by a manual input of the ATAMAN user.

EOFB=EONB+PTT

Subsequently, the take-off runway allocation for the departure is performed. The Outbound Manager optimizes the take-off runway allocation for all departures within each 10-minute interval (see FIG. 10) according to the following criteria:
minimization of the departure route by initial take-off runway allocation according to the shortest standard instrument departure route (SID) to the departure fix (preferred take-off runway);
reduction of the departure delays/departure delay costs by making the best possible use of the available take-off capacities (calculated by CAPMAN);
minimization of the taxi times/taxiing costs (and spacing out the taxiing traffic) by a parking position-dependent (optimized) runway allocation (alternative take-off runway),

and transmits its runway allocation to the relevant air traffic control systems (e.g., CLOU, DMAN, DEPCOS).

To determine its earliest time of take-off, each individual flight is assigned its expected taxi time between the parking position and the take-off threshold. The sum of all take-off times corresponds to the take-off demand within a 10-minute interval.

The take-off runway allocation is carried out in several steps, which are illustrated separately in FIG. 11. In accordance with the valid rules, at first each flight is assigned a runway with the shortest departure route to the intended departure fix as the preferred take-off runway. With the initial departure runway allocation, the take-off demand/10 min for each take-off runway is defined at the same time.

The Outbound Manager now checks whether the take-off demand for each runway can be satisfied by the respective take-off runway capacity. If this is the case, each departure is allocated its preferred take-off runway. The respective take-off runway capacity is provided to the Outbound Manager by the Capacity

Manager CAPMAN.

If the take-off demand exceeds the take-off capacity of the preferred take-off runway, the Outbound Manager checks whether free take-off capacity is available on an alternative runway in the same 10-minute interval in order to avoid departure lags and associated delay costs. In case of free capacities on an alternative runway, the Outbound Manager will propose an alternative take-off runway for use.

As a rule, one or more flights of a 10-minute interval need to be rescheduled from their preferred to an alternative take-off runway for capacity reasons, with the negative consequence for the flights concerned of a prolongation of their flight routes and/or their taxi times. The Outbound Manager performs the rescheduling processes according to defined optimization criteria.

In case of capacity bottlenecks on the preferred take-off runway, the Outbound Manager compares the standard taxi times stored in the table of taxi times from the parking position to the alternative take-off runways with free take-off capacity. To minimize departure delays, in a first optimization step, the alternative take-off runway is allocated to those flights whose times of taxiing to an alternative take-off runway are shorter than to the initial take-off runway. If the take-off capacity bottleneck on the initial take-off runway continues to exist, requiring further flights to be rescheduled in addition, the Outbound Manager determines in the second optimization step the difference in taxi times for each departure to be disposed of and calculates the taxiing costs, taking into consideration the type of aircraft (twin-jet, tri-jet, four-jet type of aircraft). In the third optimization step, the alternative take-off runway is allocated to the flight involving the lowest taxiing costs in each case.

The Outbound Manager reschedules until the take-off demand for the preferred take-off runway no longer exceeds the take-off capacity thereof or until the take-off capacity of the alternative take-off runway is exhausted.

The ATAMAN optimization of the take-off runway allocation is concluded, and the Outbound Manager transmits the departure runway allocation and the earliest take-off time to the relevant air traffic control systems (e.g., DEPCOS, DMAN). Since Air Traffic Control bears the responsibility for carrying out the flight, it may adopt or change the proposed take-off runway allocation. It allocates to each flight its departure route SID and—taking into account a CFMU slot, if any—its scheduled take-off time CTOT (calculated take-off time). The Outbound Manager adopts any changes made by Air Traffic Control. The take-off runway allocated by Air Traffic Control must not be changed by ATAMAN.

Once the take-off runway for the departure has been established, the Outbound Manager can individually calculate the expected taxi time from the parking position to the take-off threshold with the aid of the taxi times model for each individual departure. The taxi times calculating module calculates the period of time that is required by a departing aircraft from the parking position to the take-off threshold. To calculate the outbound taxi times, the Outbound Manager requires the parking position and the take-off runway. The distance is defined by defined standard taxi routes (see the corresponding section sub “optimization of the inbound process”). The calculation of the time T_{Taxi out} required for the distance between the parking position and the take-off threshold is effected analogously to the taxi inbound process already described.

The estimated time of arrival at the take-off threshold ETD is calculated from the estimated off-blocks time EOFB and the forecast outbound taxi time T_{Taxi out}:

ETD=EOFB+T_{Taxi out}

The estimated time of take-off is at the same time the estimated time of arrival at the take-off threshold ETD.

The time of departure, which is the period of time required by a departing aircraft from take-off up to leaving the airspace of the airport (flying over the departure fix), is essentially dependent on the take-off runway used. The flight route from a take-off runway to a departure fix is determined by the standard instrument departure route SID. The expected time of departure T_{Departure} to the departure fix is calculated from the SID route length and the aircraft-specific aircraft speed on this route. All departure times are stored in the ATAMAN database.

The estimated time of flying over the departure fix ETDF is calculated from the estimated take-off time ETD and the expected time of departure T_{Departure}:

ETDF=ETD+T_{Departure}

The overflight of the departure fix constitutes the end of the air-to-air process and the beginning of the en-route flight.

Utilization of the Calculated Target Times

The inbound target times TTOF and TTA and the optimum take-off runway may be made available by ATAMAN to the flight planning and control systems (e.g., CLOU, AMAN, ARRCOS). This enables the air traffic control systems to establish an approach sequence which, departing from the first-come, first-served principle, pursues the intended on-time-service principle. In addition, the calculated target times TTOF and TTA are suitable to synchronize the gate-to-gate process and the air-to-air process.

The outbound target times TTD and TTDF as well as the optimum take-off runway may be made available to the flight planning and control systems (e.g., OMAN, DEPCOS) by ATAMAN. This enables air traffic control systems to establish a departure sequence which, deviating from the standard departure route principle with a rigid runway allocation, pursues the intended on-time-service principle with a flexible runway allocation.

ATAMAN Results

The output data made available by ATAMAN will be briefly summarized again below.

The Inbound Manager receives from CAPMAN the landing capacity slots per 10-minute interval for each landing runway and allocates individual approaching flights to these capacity slots. The allocated landing runway may be displayed and transmitted to external systems (e.g., CLOU, AMAN) as a control datum for further processing. The same is applicable to the take-off runway allocation for departing flights by the Outbound Manager, which may likewise be transmitted to external systems (e.g., DMAN, DEPCOS).

In addition to the optimum landing and/or take-off runway, the Inbound Manager and the Outbound Manager calculate all relevant data of the inbound and outbound processes, respectively, and their partial processes. The comparison of the target and actual data with the planned data allows both the online representation of delays and also the forecast thereof. The delays that have arisen and the forecast delays may be attributed to individual partial processes and causes of delays may be identified. Systematic countermeasures (e.g., giving priority to individual flights) can be initiated by CLOU and AMAN and by DMAN and DEPCOS, respectively (see FIGS. 12 and 13).

The output data of ATAMAN can be used by other partner systems via external interfaces. All relevant information is displayed to the user via a human-machine interface (HMI). An example of an ATAMAN user surface including various display options will be described later.

FIG. 14 again illustrates all relevant data of the air-to-air process. The actual data is acquired by other systems and constitutes input data for ATAMAN. As soon as it is available, it replaces the estimated times. ATAMAN updates the calculation of the remaining process.

Before the flight visit reaches the Frankfurt airspace, ATAMAN receives the estimated time of flying over the entry fix ETOF. Using this input value, ATAMAN forecasts the entire process with the aid of the formulas illustrated sub “Estimated” in FIG. 14. The Inbound Manager receives the estimated time of flying over the entry fix ETOF as a flight progress datum with the departure message or calculates it as described sub “optimization of the inbound process”.

The target times are calculated by ATAMAN on the basis of the flight plan arrival time STA in the inbound process and based on the flight plan departure time STD in the outbound process.

The target time of flying over the entry fix TTOF is calculated from the time of arrival STA published in the flight plan and taking into consideration the landing runway- and parking position-dependent taxi time T_{Taxi In} and the weather- and traffic volume-dependent approach time AT. The target time for flying over the entry fix is the time at which an overflight must take place to permit an on-time arrival on the parking position. TTOF is therefore suitable as a control variable to increase the inbound punctuality by the flight operations planning system CLOU of Air Traffic Control.

The estimated time of landing ETA is calculated as described sub “optimization of the inbound process”. The target time for landing (target time of arrival) TTA is the time at which a landing must take place to permit an on-time arrival on the parking position. TTA is therefore suitable as a control variable to increase the inbound punctuality by the flight operations planning system AMAN of Air Traffic Control. TTA is calculated from the scheduled time of arrival STA minus the taxi time T_{Taxi In}.

The estimated time of arrival on the parking position EONB is calculated as described sub “optimization of the inbound process”. The times of arrival on the parking position are passed on to the Outbound Manager via an ATAMAN-internal interface for further processing.

The scheduled off-blocks time STD is at the same time the target time for the termination of the ground processes. As long as inbound flight progress data are not yet available, the scheduled time STD is deemed to be the estimated off-blocks time. Thereafter, the Outbound Manager calculates the estimated off-blocks time EOFB as a flight progress datum as described sub “optimization of the outbound process”.

The estimated take-off time ETD is calculated as described sub “optimization of the outbound process” from the estimated off-blocks time EOFB and the out-bound taxi time T_{Taxi Out} forecast by the taxi module.

The estimated time of flying over the departure fix ETDF is calculated as described sub “optimization of the outbound process”. The actual overflight of the departure fix at the time ATDF concludes the air-to-air process.

ATAMAN calculates all partial process delays and partial process lags from the air-to-air process times as illustrated in FIG. 15. The (estimated) TMA entry delay D_{ext inb} is calculated as the difference from the time (E)TOF and the time TTOF in minutes. The sum of D_{ext inb} over all approaches is the cumulative delay “brought along”. The time TOF is a flight progress datum which is acquired upon flying over the entry fix and is transmitted by Air Traffic Control. ETOF, TTOF, TOF, and D_{ext inb} may be further processed and displayed as output quantities.

The estimated approach delay D_{thr in est} is calculated from the expected time of landing ETA and the target time for the landing TTA in minutes. The actual approach delay D_{thr in} is calculated from the actual time of landing ATA and the target time for the landing TTA in minutes. The sum of D_{thr in} over all approaching flights is the cumulative approach delay. The approach process lag PDₐᵣᵣ is the difference from the approach time and the estimated approach time. The time

ATA is a flight progress datum which is acquired upon landing. ATA, ETA, TTA, D_{thr in}, and PDₐᵣᵣ may be further processed and displayed as output quantities.

The estimated arrival delay D_{onb est} is calculated from the expected time of arrival on the parking position EONB and the scheduled time of arrival STA in minutes. The actual arrival delay D_{onb} is calculated from the actual time of arrival on the parking position ONB and the scheduled time of arrival STA in minutes. The sum of D_{onb} over all arrivals is the cumulative arrival delay. The taxiing process lag PD_{taxi in} is the difference between the taxi time and the estimated taxi time. ONB is a flight progress datum which is acquired upon arrival on the parking position. EONB, D_{onb}, and D_{onb est} may be further processed and displayed as output quantities.

The estimated departure delay D_{ofb est} is calculated from the expected off-blocks time EOFB and the scheduled off-blocks time STD in minutes. The actual departure delay D_{ofb} is calculated from the actual off-blocks time OFB and the time STD (scheduled time of departure) in minutes. The sum of D_{ofb} over all approaching flights is the cumulative departure delay. The departure delay D_{ofb} may be composed as caused by different causes of delay. As already explained above, in the case of delayed arrivals and tightly scheduled regular ground times of a flight visit, departure delays may materialize which are induced by arrival delay. ATAMAN distinguishes between the departure lag caused by approach delays D_{ext out} “brought along” and the lag in the handling process, which for its part may have a variety of causes. The calculation of the departure delay and the departure lags is illustrated in FIG. 16. The time OFB is a flight progress datum acquired upon off-blocks. OFB, EOFB, D_{ofb}, P_{gnd}, and PD_{ext out} can be further processed and displayed as output quantities.

The estimated take-off delay D_{thr est} is calculated from the expected time of take-off ETD and the target time for the take-off TTD in minutes. The actual take-off delay D_{thr out} is calculated from the actual time of take-off ATD and the target time for the take-off TTD in minutes. The sum of D_{thr out} over all departures is the cumulative take-off delay. The departure process lag PD_{Taxi out} is the difference from the outbound taxi time and the estimated outbound taxi time. The time ATD is a flight progress datum acquired upon take-off. ATD, ETD, Dₜₕᵣₑₛₜ, D_{thr out}, and PD_{taxi out} may be further processed and displayed as output quantities.

ATAMAN User Surface

An example of an ATAMAN user surface (ATAMAN-HMI) including various display options will now be described below. The ATAMAN-HMI informs of the actual and expected punctuality of individual flights and of the air traffic at the airport as a whole. In addition, the ATAMAN-HMI informs the operating control staff of the actual traffic situation in the TMA and the traffic situation in the TMA to be expected within the next few hours, on the runways and in the taxiing traffic (in particular delays and lags). In this way, it opens up the possibility of initiating target-oriented traffic control measures relating to individual flights in a timely manner. The ATAMAN-HMI consists of a plurality of representations which are able to display all relevant information about the air-to-air process at the same time.

The capacity/runway allocation monitor visualizes all available and allocated take-off and landing capacity slots per take-off/landing runway, as illustrated as an example in FIG. 17. All available landing capacity slots (e.g., in light red color) and all available take-off capacity slots (e.g., in light blue color) which ATAMAN has received from CAPMAN are made visible to the user by a human-machine interface. ATAMAN assigns individual flights to the available capacity slots of a 10-minute interval. The occupied capacity slots are shown, e.g., in a dark red color for landings and, e.g., in a dark blue color for take-offs, so that occupied and non-occupied capacity slots can be distinguished from each other.

ATAMAN provides all important information about the flight visit of an individual flight to the flight visit monitor via a human-machine interface. The flight visit monitor visualizes this information for the user, as is illustrated by way of example in FIG. 18. This illustration shows the flight progress status and the delay status of each individual flight visit as well as the process lags of each partial process (approach, taxi inbound, parking, taxi outbound, departure). In the flight progress status, the target times (Target), the estimated times (Estimated) and the acquired actual times (Actual) are displayed for each partial process. In the delay status, the respectively forecast (Estimated) and measured (Actual) delays are illustrated for each important process time. In addition, the process lags that have occurred in each partial process are displayed. (The hatched delay illustrations are based on forecast flight progress data.)

ATAMAN provides to the air-to-air process monitor all traffic information in the partial processes of the air-to-air process via a human-machine interface. The air-to-air process monitor visualizes the volume of traffic (traffic demand) per hour for the user, as illustrated by way of example in FIG. 19. The illustration shows the inbound traffic that has already taken off (en-route flight) and the volume of traffic in the air-to-air process for each partial process (approach, taxi inbound, parking, taxi outbound, departure).

For each 10-minute interval, ATAMAN calculates and forecasts the traffic load in the five partial processes, the partial process lags, and the respective cumulative delays. ATAMAN provides to the air-to-air process monitor all delay information at the partial process transitions (important process times) of the air-to-air processes via a human-machine interface. The air-to-air process monitor visualizes the delay characteristic values (average delay per flight) for the user, as illustrated by way of example in FIG. 20. The illustration shows the delay status of the air-to-air process for each important process time (overflight entry fix, landing, on-blocks, off-blocks, and take-off). (The hatched delay illustrations are based on forecast flight progress data.) Any arising bottleneck situations which are calculated on the basis of actual flight progress data may be identified at an early point in time in this way. This allows goal-oriented individual flight-related countermeasures, e.g. control measures to be taken by the user.

ATAMAN provides to the air-to-air process monitor all lag information in the partial processes of the air-to-air process via a human-machine interface. The air-to-air process monitor visualizes the lag characteristic values (average lag per flight) for the user, as illustrated by way of example in FIG. 21. The illustration shows the lag status of the air-to-air process for each partial process (approach, taxi inbound, parking, taxi outbound, departure). This illustration allows, on the one hand, the distinction between delays that are “brought along” and lags arising at the airport and, on the other hand, allows causes of delays within the air-to-air process to be attributed by the user. The off-blocks lags may have a variety of causes. More detailed information about the ground partial process may be retrieved by clicking on the respective off-blocks bar.

ATAMAN provides to the air-to-air process monitor all available ground delay information of the air-to-air process via a human-machine interface. The air-to-air process monitor visualizes this information for the user, as illustrated by way of example in FIG. 22. This illustration provides a detailed overview of arrival delays brought along (delay on-blocks), individual minimum turnaround time (MTT), and any externally induced off-blocks delays resulting therefrom, scheduled ground time, and delays caused by the ground handling.

List of Abbreviations

| Abbreviation | Meaning |
|---|---|
| ACI | Airports Council International |
| AMAN | Arrival Management System |
| ARRCOS | Arrival Coordination System |
| AT | Weather- and traffic volume-dependent Approach Time |
| AT₀ | Approach Time without influence of temperature |
| AT_{Min} | Measured Minimum Approach Time |
| AT_{Mov} | Approach Time prolongation due to influence of traffic |
| AT_{RWY} | Time difference of Approach Times depending on landing direction |
| ATₜₑₘₚ | Approach Time prolongation due to influence of temperature |
| AT_{wind} | Approach Time prolongation due to influence of wind |
| ATA | Measured time of landing (Actual Time of Arrival) |
| ATAMAN | Air-to-Air Process Manager |
| ATD | Measured time of take-off (Actual Time of Departure) |
| ATDF | Measured time of flying over the Departure Fix (Actual Time |
| | over Departure Fix) |
| ATM | Air Traffic Management |
| CAPMAN | Capacity Manager |
| CFMU | Central Flow Management Unit |
| CLOU | Cooperative Local Resource Planning System |
| COB | Confirmed Off-Blocks Time |
| CTOT | Scheduled time of take-off (Calculated Take-off Time) |
| D | Delay |
| D_{ext inb} | Estimated TMA entry delay |
| D_{ext out} | Departure delay status induced by arrival delay |
| D_{ofb} | Actual departure delay (position-related) |
| D_{ofb est} | Estimated departure delay (position-related) |
| D_{onb} | Actual arrival delay (position-related) |
| D_{onb est} | Estimated arrival delay (position-related) |
| D_{thr est} | Estimated take-off delay (threshold-related) |
| D_{thr in} | Actual approach delay (threshold-related) |
| D_{thr in est} | Estimated approach delay (threshold-related) |
| D_{thr out} | Actual take-off delay (threshold-related) |
| DEPCOS | Departure Coordination System |
| DMAN | Departure Management System |
| EONB | Estimated On-Blocks Time |
| EOFB | Estimated Off-Blocks Time |
| ETA | Estimated time of landing (Estimated Time of Arrival) |
| ETD | Estimated time of take-off (Estimated Time of Departure) |
| ETDF | Estimated time of flying over the Departure Fix (Estimated |
| | Time over Departure Fix) |
| ETOF | Estimated time of flying over the Entry Fix (Estimated Time |
| | over Entry Fix) |
| FB | Cumulative volume of inbound traffic |
| Flight Visit | Overall individual flight process (arrival - handling - departure) |
| HMI | User interface (Human-Machine Interface) |
| IMC | Instrument Meteorological Conditions |
| MMC | Mediocre Meteorological Conditions |
| MTT | Minimum Turnaround Time |
| PD | Process Lag (Process Delay) |
| PDₐᵣᵣ | Approach process lag |
| PD_{ext out} | External ground delay |
| PD_{gnd} | Process lags caused by ground handling |
| PD_{taxi in} | Taxiing process lag |
| PD_{taxi out} | Departure process lag |
| PTT | Predicted Turnaround Time |
| RWY | Runway |
| SGMAN | Stand and Gate Manager |
| SID | Standard Instrument Departure Route |
| STA | Time of arrival according to published flight plan (Scheduled |
| | Time of Arrival) |
| STAR | Standard Arrival Route |
| STD | Time of take-off according to published flight plan |
| | (Scheduled Time of Departure) |
| T_{Departure} | Expected time of departure |
| T_{Def Approach} | Defined standard approach time |
| T_{Def Taxi in} | Defined standard taxi inbound time |
| T_{Taxi in} | Taxi time from runway exit to parking position |
| T_{Taxi inb} | Forecast taxi inbound time |
| T_{Taxi out} | Forecast taxi time from parking position to take-off threshold |
| TMA | Terminal Maneuvering Area |
| TOF | Time of flying over the Entry Fix (Time over Fix) |
| TTA | Target time of landing (Target Time of Arrival) |
| TTD | Target time of take-off (Target Time of Departure) |
| TTDF | Target time of flying over the Departure Fix |
| | (Target Time over Departure Fix) |
| TTOF | Target time of flying over the Entry Fix |
| | (Target Time over Entry Fix) |
| V_{wind} | Wind velocity |
| VMC | Visual Meteorological Conditions |

1. A method for the control of air traffic management at an airport, in which, by using an electronic data processing system, optimized partial process sequences for the visit of an individual aircraft at the airport (flight visit) are determined including actual and/or forecast factors.

2. The method according to claim 1, wherein an optimum take-off and/or landing runway is determined dynamically for a flight visit having regard to at least one of the following actual or forecast factors:
landing and/or take-off demand;
available landing and/or take-off capacities of each usable landing and/or take-off runway;
taxi route from the landing runway to the parking position and/or from the parking position to the take-off runway;
taxiing costs for the taxi route.

3. The method according to claim 1, wherein the determined landing and/or take-off runway is transmitted to Air Traffic Control of the airport.

4. The method according to claim 1, wherein the duration of at least one of the following partial processes of the flight visit limited by defined process times is calculated having regard to actual or forecast factors:
approach, limited by the time of flying over the entry fix (TOF) and the time of landing (ATA);
taxi inbound, limited by the time of landing (ATA) and the on-blocks time (ONB);
taxi outbound, limited by the off-blocks time (OFB) and the time of take-off (ATD);
departure, limited by the time of take-off (ATD) and the time of flying over the departure fix (ATDF).

5. The method according to claim 4, wherein the duration of the “approach” partial process is calculated having regard to at least one of the following actual or forecast factors:
volume of inbound traffic;
approach route;
landing runway;
wind/weather conditions.

6. The method according to claim 4, wherein the duration of the “taxi inbound” partial process is calculated having regard to at least one of the following actual or forecast factors:
landing runway;
parking position;
volume of taxiing traffic;
wind/weather conditions;
taxi route from the landing runway to the parking position;
runway/taxiway intersections;
type of aircraft.

7. The method according to claim 4, wherein the duration of the “taxi outbound” partial process is calculated having regard to at least one of the following actual or forecast factors:
parking position;
take-off runway;
volume of taxiing traffic;
wind/weather conditions;
taxi route from the parking position to the take-off runway;
runway/taxiway intersections;
type of aircraft.

8. The method according to claim 4, wherein the duration of the “departure” partial process is calculated having regard to at least one of the following actual or forecast factors:
volume of outbound traffic;
departure route;
take-off runway;
wind/weather conditions.

9. The method according to claim 4, wherein at least one estimated process time of the flight visit is calculated including at least one previously calculated duration of a partial process.

10. The method according to claim 9, wherein at least one of the following process times is calculated:
estimated time of flying over the entry fix (ETOF);
estimated time of landing (ETA);
estimated on-blocks time (EONB);
estimated off-blocks time (EOFB);
estimated time of take-off (ETD);
estimated time of flying over the departure fix (ETDF).

11. The method according to claim 4, wherein at least one target process time of the flight visit is calculated including at least one previously calculated duration of a partial process.

12. The method according to claim 11, wherein at least one of the following target process times is calculated:
target time of flying over the entry fix (ETOF);
target time of landing (TTA).

13. The method according to claim 12, wherein the calculated target process times are transmitted to Air Traffic Control of the airport.

14. The method according to claim 9, wherein for a flight visit the estimated delay for at least one defined process time is calculated having regard to at least one calculated estimated process time and the corresponding calculated target process time.

15. The method according to claim 1, wherein the calculations are carried out dynamically.

16. The method according to claim 1, comprising an air-to-air process for coordinating the movements of the aircraft at the airport and a gate-to-gate process for the control of long-distance flights including the departure and/or approach phase, characterized in that the air-to-air process is coupled to the gate-to-gate process by including information of the air-to-air process into the gate-to-gate process and/or information of the gate-to-gate process into the air-to-air process.

17. A device for carrying out the method according to claim 1.

18. An information system comprising an electronic data processing system which executes a computer program which is used to determine and/or calculate at least one of the following items of information using the results of the method according to claim 1, and comprising a screen for display of the item of information:
overview of the utilization of the available take-off and landing runways;
overview of the target process times, the estimated process times, and the actual process times of a flight visit;
indication of the delays for each partial process of a flight visit;
overview of the entire volume of traffic at the airport as related to the partial processes of the flight visits in specific time intervals;
overview of the average delays as related to the partial processes or the process times of the flight visits in specific time intervals;
overview of the average lags as related to the partial processes or the process times of the flight visits in specific time intervals; and
overview of the delays in the ground handling of the flight visits.

19. The method according to claim 5, wherein the duration of the “taxi inbound” partial process is calculated having regard to at least one of the following actual or forecast factors:
landing runway;
parking position;
volume of taxiing traffic;
wind/weather conditions;
taxi route from the landing runway to the parking position;
runway/taxiway intersections;
type of aircraft.

20. The method according to claim 5, wherein the duration of the “taxi outbound” partial process is calculated having regard to at least one of the following actual or forecast factors:
parking position;
take-off runway;
volume of taxiing traffic;
wind/weather conditions;
taxi route from the parking position to the take-off runway;
runway/taxiway intersections;
type of aircraft.

21. The method according to claim 6, wherein the duration of the “taxi outbound” partial process is calculated having regard to at least one of the following actual or forecast factors:
parking position;
take-off runway;
volume of taxiing traffic;
wind/weather conditions;
taxi route from the parking position to the take-off runway;
runway/taxiway intersections;
type of aircraft.
